(19) United States
(12) Patent Application Publication
(10) Pub. No.: US 2008/0023312 A1
(43) Pub. Date: Jan. 31, 2008

(54) KEYBOARD AND KEY ASSEMBLY THEREON

(75) Inventor: Kuo-Chiang Chin, Taoyuan County (TW)

Correspondence Address: QUINTERO LAW OFFICE, PC, 2210 MAIN STREET, SUITE 200, SANTA MONICA, CA, 90405, US

(73) Assignee: DARFON ELECTRONICS CORP., TAOYUAN (TW)

(21) Appl. No.: 11/781,886

(22) Filed: Jul. 23, 2007

(30) Foreign Application Priority Data
Jul. 25, 2006 (TW) TW95127088

(51) Int. Cl. H01H 13/70

(52) U.S. Cl. 200/345

(57) ABSTRACT

A keyboard comprises a plurality of key assemblies and an elastic layer. The key assembly includes a key and a base. The base includes a plurality of opening. The key includes a keycap and a key pillar connected to the keycap. The key pillar vertically moves in the opening. The key pillar includes a bottom surface and a plurality of protrusions protruding from the bottom surface. The elastic layer includes a plurality of flexible portions. Each flexible portion includes a top portion. The protrusions surround the top portion for limiting the position of the flexible portion.

### BACKGROUND OF THE INVENTION

1. Field of the Invention

The invention relates to a keyboard and a key assembly thereon.

2. Description of the Related Art

Referring to FIG. 1, a conventional key assembly 10 comprises a base 11, a key 12 and an elastic layer 13. The base 11 comprises an opening 111. The key 12 comprises a keycap 121 and a key pillar 122. The keycap 121 is connected to the key pillar 122. The key pillar 122 in the opening 111 moves upward and downward. The key pillar 122 comprises a bottom surface 123. The elastic layer 13 comprises a plurality of flexible portions 131. Each flexible portion 131 comprises a top portion 132. After assembling the base 11, the key 12 and the elastic layer 13, the bottom surface 123 of the key pillar 122 is connected to the top portion 132 of the elastic layer 13. Note that the bottom surface 123 only contacts with but is not fixed to the top portion 132. When pushing the key 12, the bottom surface 123 does not press the flexible top portion 132 uniformly. Thus, the flexible portion 131 may move slantwise and the key 12 may not spring back or spring back smoothly.

### BRIEF SUMMARY OF INVENTION

A detailed description is given in the following embodiments with reference to the accompanying drawings. The invention provides a keyboard comprising a plurality of key assemblies and an elastic layer. The key assembly includes a key and a base. The base includes a plurality of opening. The key comprises a keycap and a key pillar connected to the keycap. The key pillar vertically moves in the opening. The key pillar includes a bottom surface and a plurality of protrusions protruding from the bottom surface. The elastic layer includes a plurality of flexible portions. Each flexible portion includes a top portion, limited by protrusions.

### BRIEF DESCRIPTION OF DRAWINGS

The invention can be more fully understood by reading the subsequent detailed description and examples with references made to the accompanying drawings, wherein:

FIG. 1 is a schematic view of a conventional keyboard;

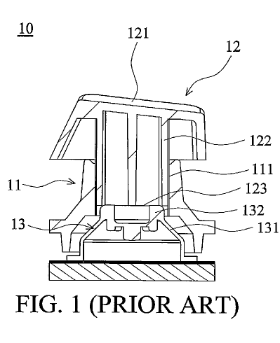

FIG. 2 is a schematic view of a keyboard of the invention;

FIG. 3 is an exploded view of a keyboard of the invention;

FIGS. 4A and 4B show the process of pressing on a key.

### DETAILED DESCRIPTION OF INVENTION

The following description is of the best-contemplated mode of carrying out the invention. This description is made for the purpose of illustrating the general principles of the invention and should not be taken in a limiting sense. The scope of the invention is best determined by reference to the appended claims.

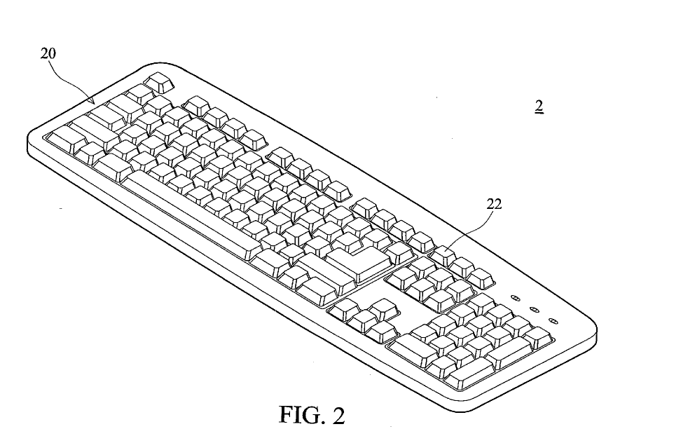

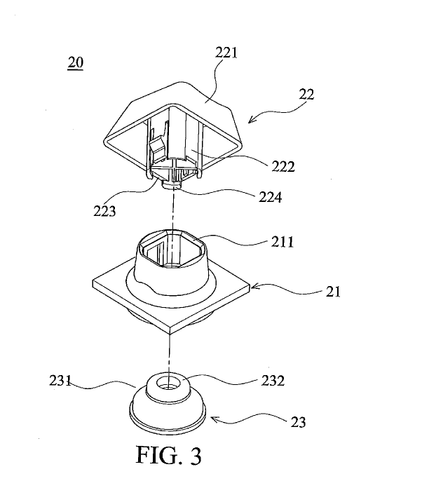

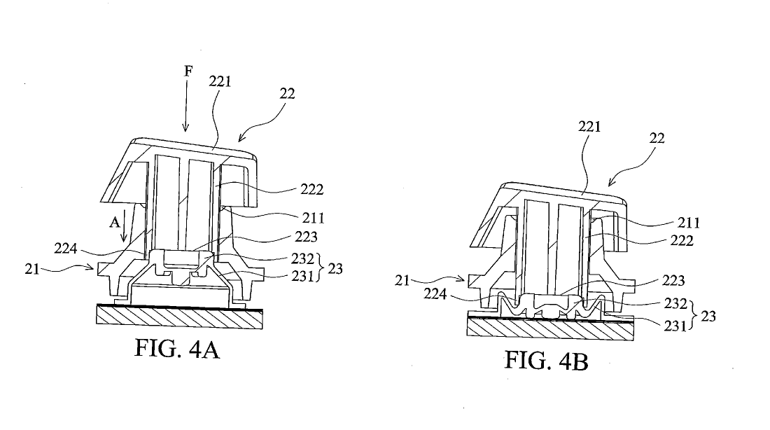

Referring to FIGS. 2 and 3, a keyboard 2 comprises a plurality of key assemblies 20. Each key of the key assemblies 20 comprises a base 21, a key 22 and an elastic layer 23. The base 21 comprises an opening 211. Each key comprises a keycap 221 and a key pillar 222. The keycap 221 is connected to the key pillar 222. The key pillar 222 passing through the opening 211 moves upward and downward. The key pillar 222 comprises a bottom surface 223 and a plurality of protrusions 224. The protrusions 224 protrude from the bottom surface 223. The elastic layer 23 comprises a plurality of flexible portions 231 with a top portion 232. After assembling the base 21, the key 22 and the elastic layer 23, the protrusions 224 of the key pillar 222 surround the flexible top portion 232 of the elastic layer 23 (shown in FIG. 4A). Thus, when pushing the key 22, the flexible top portion 232 is limited by the protrusions 224 of the key pillar 222.

FIGS. 4A to 4B show the process of pressing on a key 22. FIG. 4A shows the key 22 not pressed yet. The bottom surface 223 of the key pillar 222 contacts with the top portion 232 of the elastic layer 23. The top portion 232 of the elastic layer 23 is limited to keep the position in the inner side of the protrusions 224. When downward force F is exerted on the key 22, the key 22 moves along an arrow A. Referring to FIG. 4B, the top portion 232 of the flexible portions 231 is limited by the protrusions 224 of the key pillar 222. Thus, even if the key 22 moves along the arrow A, the flexible top portion 232 is still limited by the protrusions 224. Thus, the flexible portion 231 does not move slantwise and the key 12 is able to spring back smoothly.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A keyboard, comprising:
a plurality of key assemblies, wherein each key of the key assemblies comprises a base and a key; the key comprises a keycap and a key pillar connected to the keycap; the base comprises an opening and the key pillar vertically moves in the opening; the key pillar comprises a bottom surface and a plurality of protrusions protruding from the bottom surface; and
an elastic layer comprising a plurality of flexible portions, wherein each flexible portion comprises a top portion;
wherein the protrusions surround the top portion.

2. The keyboard as claimed in claim 1, wherein the elastic layer is disposed in the base.

3. A key assembly, comprising:
a base comprising an opening; and
a key comprising a keycap and a key pillar connected to the keycap;
wherein the key pillar vertically moves in the opening; the key pillar comprises a bottom surface and a plurality of protrusions protruding from the bottom surface.

4. The key assembly as claimed in claim 3, further comprising a flexible portion disposed between the base and the key, wherein the flexible portion comprises a top portion, the protrusion surrounds the top portion.
